(19) United States
(12) Patent Application Publication
(10) Pub. No.: US 2024/0071671 A1
(43) Pub. Date: Feb. 29, 2024

(54) INDUCTOR

(71) Applicant: Murata Manufacturing Co., Ltd., Kyoto-fu (JP)

(72) Inventors: Keita MUNEUCHI, Nagaokakyo-shi (JP); Masayoshi MIYAKAWA, Nagaokakyo-shi (JP); Takehiro YAWATA, Nagaokakyo-shi (JP)

(73) Assignee: Murata Manufacturing Co., Ltd., Kyoto-fu (JP)

(21) Appl. No.: 18/366,506

(22) Filed: Aug. 7, 2023

(30) Foreign Application Priority Data
Aug. 30, 2022 (JP) 2022-136629

(51) Int. Cl. H01F 17/00; H01F 27/28; H01F 27/29

(52) U.S. Cl. CPC H01F 17/0013; H01F 27/2828; H01F 27/292

(57) ABSTRACT

An inductor includes a base body including a coil conductor and a core in which the coil conductor is embedded. The coil conductor includes a wound section in which a conductive wire is wound. The base body is substantially rectangular-parallelepiped-shaped and includes a pair of principal faces that are opposite to each other, a pair of side faces that are opposite to each other and adjacent to the principal faces, and two end faces that are opposite to each other and adjacent to the principal and side faces. Two extended sections extend from respective ones of two extending points on an outer periphery of the wound section. The two extended sections include respective transition portions and respective exposed portions, the transition portions connect the extending points to exposed points exposed on the two end faces of the base body, and the exposed portions are exposed on the end faces.

### CROSS-REFERENCE TO RELATED APPLICATION

This application claims benefit of priority to Japanese Patent Application No. 2022-136629, filed Aug. 30, 2022, the entire content of which is incorporated herein by reference.

### BACKGROUND

### Technical Field

The present disclosure relates to an inductor.

### Background Art

Japanese Unexamined Patent Application Publication No. 2016-058418 describes a surface-mounted inductor including a base body (molded body) in which a coil conductor is embedded in a core. The coil conductor is formed by winding a conductive wire. The core contains magnetic powder and a resin. The coil conductor is embedded such that surfaces of extended end sections (hereinafter referred to as extended sections) of the coil conductor are exposed on surfaces of the base body. Portions of the surfaces of the base body on which the extended sections are exposed are subjected to, for example, laser irradiation, and then external terminals are formed thereon by plating.

The direct-current resistance of the inductor tends to increase with increasing length along the coil conductor between a wound section of the coil conductor and a portion of each extended section exposed on a surface of the base body.

### SUMMARY

Accordingly, the present disclosure provide a configuration that enables reduction in the direct-current resistance of an inductor.

According to an aspect of the present disclosure, an inductor includes a base body including a coil conductor and a core in which the coil conductor is embedded, the coil conductor including a wound section in which a conductive wire is wound. The base body is substantially rectangular-parallelepiped-shaped and includes a pair of principal faces that are opposite to each other, a pair of side faces that are opposite to each other and adjacent to the principal faces, and two end faces that are opposite to each other and adjacent to the principal faces and the side faces. Two extended sections extend from respective ones of two extending points on an outer periphery of the wound section, the two extended sections including respective transition portions and respective exposed portions. The transition portions connect the extending points to exposed points exposed on the two end faces of the base body, and the exposed portions are exposed on the end faces. The two exposed portions are connected to respective outer electrodes. At least one of the exposed points is positioned to face the wound section with a tangent line disposed therebetween when viewed in a direction normal to the principal faces. The tangent line is a tangent line of an outer periphery of the wound section at a corresponding one of the extending points.

The present disclosure provides a configuration that enables reduction in the direct-current resistance of an inductor.

### BRIEF DESCRIPTION OF THE DRAWINGS

FIG. 1 is a perspective view of an inductor according to an embodiment of the present disclosure viewed from above a top face;

FIG. 2 is a perspective view of the inductor viewed from below a bottom face;

FIG. 3 is a see-through perspective view illustrating the internal structure of the inductor;

FIG. 4 is a flowchart of steps for manufacturing the inductor;

FIG. 5 is a plan view of a coil conductor viewed from above the top face;

FIG. 6 is a sectional view of a relevant part of the coil conductor taken along a plane parallel to principal faces; and

FIG. 7 is a side view of the inductor viewed from the side of an end face.

### DETAILED DESCRIPTION

An embodiment of the present disclosure will be described with reference to the drawings.

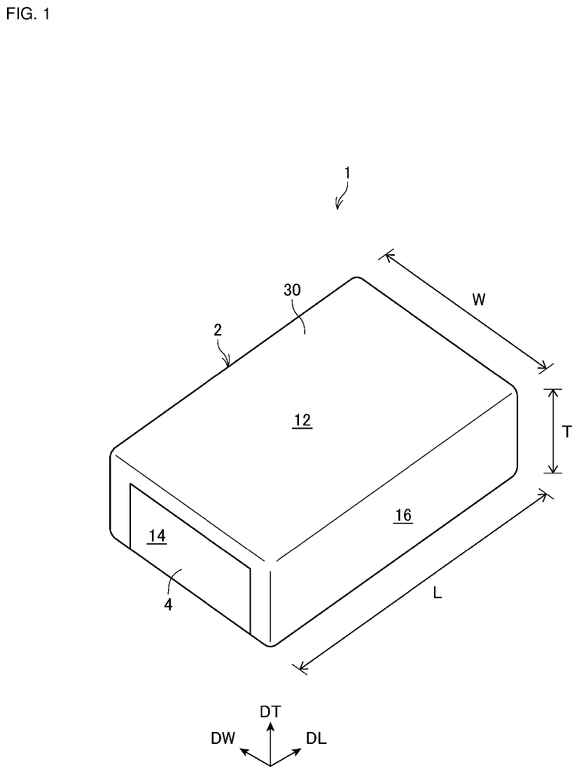

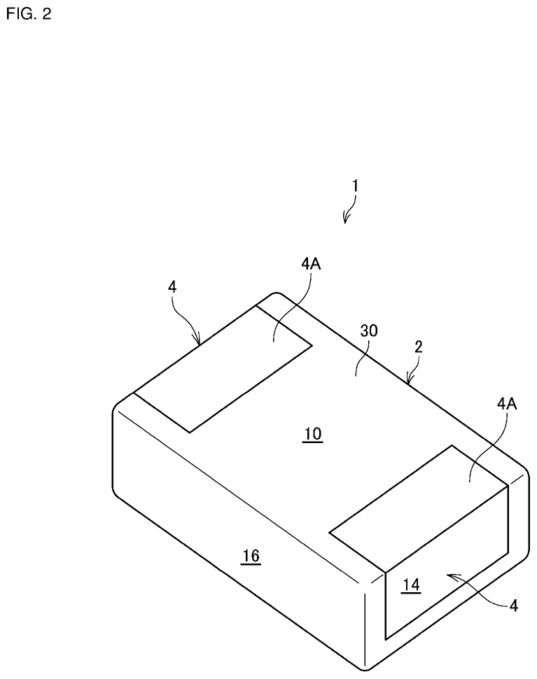

FIG. 1 is a perspective view of an inductor according to the present embodiment viewed from above a top face 12. FIG. 2 is a perspective view of the inductor viewed from below a bottom face 10.

The inductor according to the present embodiment is configured as a surface-mounted electronic component, and includes a base body 2 having a substantially rectangular parallelepiped shape, which is an example of a substantially hexahedron shape, and a pair of outer electrodes 4 provided on a surface of the base body 2.

In the following description, a first principal face of the base body 2 that faces a mounting board (not illustrated) in a mounting process is defined as the bottom face 10, a second principal face that is opposite to the bottom face 10 as the top face 12, a pair of third principal faces orthogonal to the bottom face 10 as end faces 14, and a pair of fourth principal faces orthogonal to the bottom face 10 and the pair of end faces 14 as side faces 16.

As illustrated in FIG. 1, the distance from the bottom face 10 to the top face 12 is defined as a thickness T of the base body 2, the distance between the pair of side faces 16 as a width W of the base body 2, and the distance between the pair of end faces 14 as a length L of the base body 2. The direction of the thickness T is defined as a thickness direction DT, the direction of the width W as a width direction DW, and the direction of the length L as a length direction DL. The thickness direction DT is a direction normal to the top face 12 and the bottom face 10. The width direction DW is a direction normal to the side faces 16. The length direction DL is a direction normal to the end faces 14.

The inductor has, for example, a length L of 2.0 mm, a width W of 1.6 mm, and a thickness T of 1.1 mm.

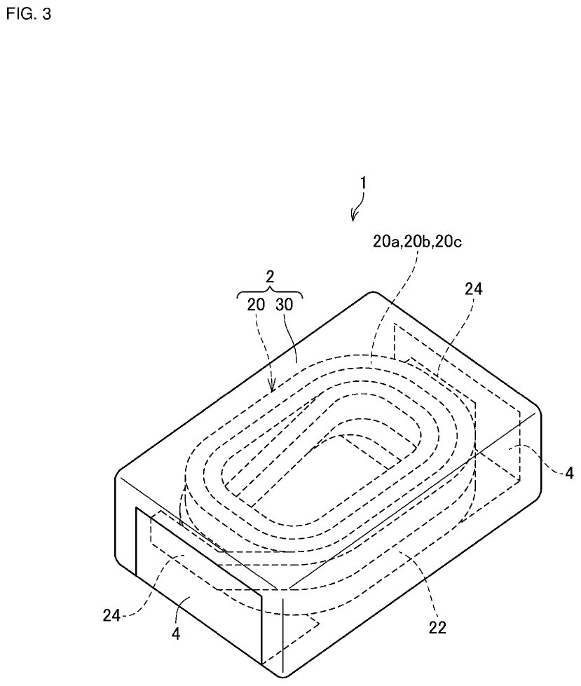

FIG. 3 is a see-through perspective view illustrating the internal structure of the inductor.

The base body 2 includes a coil conductor 20 and a core 30 having a substantially hexahedron shape in which the coil conductor 20 is embedded. The base body 2 is configured as a molded inductor in which the coil conductor 20 is sealed in the core 30.

The core 30 is a compression-molded body formed in a substantially hexahedron shape by applying heat and pressure to mixed powder containing soft magnetic particles and a resin while the coil conductor 20 is embedded in the mixed powder.

In the present embodiment, the soft magnetic particles contain two types of particles having different particle sizes: first magnetic particles that are large particles having a relatively large average particle size, and second magnetic particles that are small particles having a relatively small average particle size. Accordingly, during compression molding, the second magnetic particles, which are small particles, enter the spaces between the first magnetic particles, which are large particles, together with the resin. Thus, the packing fraction of the magnetic particles in the core 30 can be increased, and the core 30 can have a higher magnetic permeability.

In the present embodiment, the first magnetic particles and the second magnetic particles include metal particles having average particle sizes of 24.4 μm and 1.7 μm, respectively. The average particle size of the first magnetic particles is preferably 7 μm or more and 60 μm or less (i.e., from 7 μm to 60 μm), and the average particle size of the second magnetic particles is preferably 1 μm or more and 4 μm or less (i.e., from 1 μm to 4 μm). The magnetic particles may further contain particles having an average particle size different from those of the first magnetic particles and the second magnetic particles. Thus, the magnetic particles may contain three or more types of particles having different particle sizes.

Both the first magnetic particles and the second magnetic particles are particles including metal particles whose surfaces are covered with an insulating film having a film thickness of several nanometers or more and several tens of nanometers or less (i.e., from several nanometers to several tens of nanometers). Since the metal particles are covered with the insulating film, the insulation resistance and the withstand voltage can be increased.

The first magnetic particles according to the present embodiment are formed by using Fe—Si—B amorphous alloy powder as the metal particles and a film of zinc phosphate glass having a thickness of 10 nm or more and 50 nm or less (i.e., from 10 nm to 50 nm) as the insulating film. The second magnetic particles according to the present embodiment are formed by using carbonyl iron powder as the metal particles and a silica film having a thickness of 5 nm or more and 15 nm or less (i.e., from 5 nm to 15 nm) as the insulating film.

The material of the resin contained in the mixed powder according to the present embodiment is an epoxy resin containing phenol alkyl epoxy resin as the base resin.

In the present embodiment, the mixed powder contains 75±10 wt % of the first magnetic particles, 25±10 wt % of the second magnetic particles, and 2.7 wt % or more and 3.5 wt % or less (i.e., from 2.7 wt % to 3.5 wt %) of the resin.

As illustrated in FIG. 3, the coil conductor 20 includes a wound section 22 in which a conductive wire 20a is wound and a pair of extended sections 24 extending from the wound section 22.

The coil conductor 20 includes the conductive wire 20a and a covering layer formed on a surface of the conductive wire. The conductive wire 20a is a band-shaped conductive wire (so-called flat conductive wire) made of copper and having a rectangular cross section. The conductive wire 20a has a thickness of 18 μm or more and 90 μm or less (i.e., from 18 μm to 90 μm) and a width of 240 μm or more and 340 μm or less (i.e., from 240 μm to 340 μm). The covering layer includes an insulating layer 20b formed on a surface of the band-shaped conductive wire and a fusion layer 20c formed on a surface of the insulating layer 20b. The fusion layer 20c serves to join overlapping portions of the band-shaped conductive wire in the wound section 22. The insulating layer 20b is made of a polyimide-amide resin and has a thickness of 6±2 μm. The fusion layer 20c is made of a polyimide resin and has a thickness of 2.5±1.0 μm. The coil conductor may have curved thickness surfaces, and the width of the conductive wire covers the regions in which the thickness surfaces are curved.

The wound section 22 of the coil conductor 20 is formed by winding the conductive wire 20a in a helical shape so that both ends of the band-shaped conductive wire (hereinafter also referred to simply as a conductive wire) extend to the outer periphery and that portions thereof are connected to each other at the inner periphery. In the base body 2, the coil conductor 20 is embedded in the core 30 in an orientation such that a central axis of the wound section 22 extends in the thickness direction DT of the base body 2. The extended sections 24 extend from the wound section 22 to respective ones of the pair of end faces 14. One principal face of each extended section 24 is exposed on the base body 2, and the other principal face is embedded in the base body 2. The one principal face of each extended section 24 that is exposed on the base body 2 is electrically connected to a corresponding one of the outer electrodes 4.

Each of the pair of outer electrodes 4 is a so-called L-shaped electrode composed of an L-shaped member extending from a corresponding one of the end faces 14 of the base body 2 to the bottom face 10. The outer electrodes 4 are connected to respective ones of the extended sections 24 of the coil conductor 20 on the end faces 14. Portions 4A (FIG. 2) of the outer electrodes 4 extending along the bottom face 10 are electrically connected to wiring lines on a circuit board by appropriate mounting means, such as solder.

A base-body protection layer (not illustrated) is formed on the surface of the base body 2 over regions excluding the regions in which the outer electrodes 4 are provided. The base-body protection layer is made of, for example, a phenoxy resin and a novolak resin and contains nano silica as a filler. The base-body protection layer is formed on the surface of the base body 2 to a thickness of 10 μm or more and 30 μm or less (i.e., from 10 μm to 30 μm).

According to the inductor having the above-described structure, direct-current superposition characteristics can be improved by using magnetic particles made of a soft magnetic material. Accordingly, the inductor may be used as an electronic component of an electric circuit through which a large current flows, or as a choke coil conductor of a DC-DC converter circuit or a power supply circuit. The inductor may also be used as an electronic component of an electronic device, such as a personal computer, a DVD player, a digital camera, a television set, a cellular phone, a smartphone, a car electronic device, or a medical or industrial device. The application of the inductor is not limited to this, and the inductor may also be used in, for example, a tuning circuit, a filter circuit, or a rectifying-smoothing circuit.

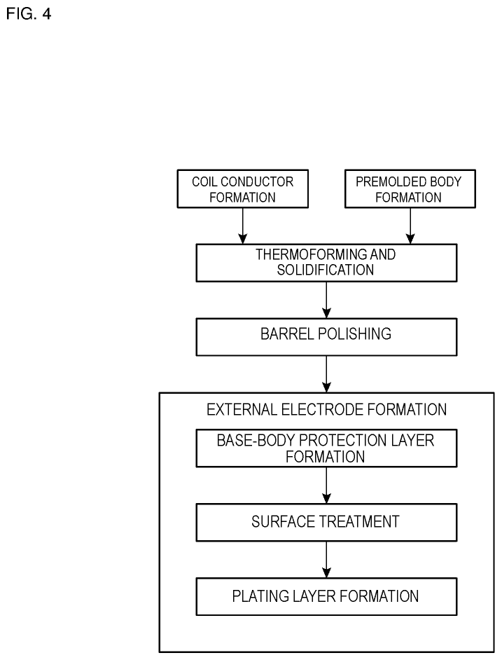

FIG. 4 is a flowchart of steps for manufacturing the inductor.

As illustrated in FIG. 4, the steps for manufacturing the inductor includes a coil conductor formation step, a premolded body formation step, a thermoforming-and-solidification step, a barrel polishing step, and an outer electrode formation step.

In the coil conductor formation step, the conductive wire 20a is formed into the coil conductor 20. In this step, the coil conductor 20 having a shape including the above-described wound section 22 and the pair of extended sections 24 is formed by winding the conductive wire 20a by a winding method called “alpha winding”. Alpha winding is a winding method in which the conductive wire 20a, which serves as a conductor, is spirally wound in each layer of two layers so that the extended sections 24 at the starting and finishing ends are positioned at the outer periphery. The number of turns of the coil conductor 20 is not particularly limited.

In the premolded body formation step, premolded bodies called tablets are formed.

The premolded bodies are bodies formed by compressing the above-described mixed powder, which is the material of the base body 2, into a solid shape that is easy to handle. In the present embodiment, two types of tablets, which are a first tablet and a second tablet, are formed. The first tablet has an appropriate shape (for example, an E-shape) including a groove for receiving the coil conductor 20. The second tablet has an appropriate shape (for example, an I-shape or a plate shape) that covers the groove in the first tablet.

In the thermoforming-and-solidification step, the first tablet, the coil conductor, and the second tablet are placed in a mold and pressed in a direction in which the first and second tablets are stacked while heat is applied thereto, so that the first and second tablets are solidified. As a result, the first tablet, the coil conductor, and the second tablet are integrated together. Thus, the base body 2 in which the coil conductor 20 is embedded in the core 30 is formed.

In the barrel polishing step, the molded body is subjected to barrel polishing. As a result of this step, the corners of the base body 2 are rounded.

In the outer electrode formation step, the outer electrodes 4 are formed on the core 30. The outer electrode formation step includes a base-body protection layer formation step, a surface treatment step, and a plating layer formation step.

In the base-body protection layer formation step, the molded body is coated with an insulating resin over the entire surface thereof.

In the surface treatment step, the surface of the core 30 is irradiated with laser light in electrode formation regions, so that the surface is reformed in the electrode formation regions. The electrode formation regions are regions of the surface of the core 30 in which the outer electrodes 4 are to be formed. These regions include regions in which the extended sections 24 are exposed. More specifically, the surface of the core 30 is irradiated with laser light so that, in the electrode formation regions, the base-body protection layer on the surface of the core 30 and the covering layer of the extended sections 24 of the coil conductor 20 are removed. In addition, the resin on the surface of the core 30 is removed, and the insulating film on the surfaces of the magnetic particles exposed on the core 30 is also removed. As a result, the area of the regions in which the metal of the magnetic particles is exposed on the surface of the core 30 per unit area is greater in the electrode formation regions than in other regions of the surface of the core 30. After the irradiation with laser light, a cleaning process (for example, an etching process) may be performed to clean the surface in the electrode formation regions.

In the plating layer formation step, the surface of the core 30 is plated with copper by barrel plating, so that a copper plating layer is formed in the electrode formation regions that have been irradiated with laser light. A Ni plating layer and a Sn plating layer may be additionally formed on the copper plating layer.

As a result of the above-described outer electrode formation step, the outer electrodes 4 composed of the above-described plating layers are formed.

Each outer electrode 4 is not limited to the L-shaped electrode, and may be a so-called five-sided electrode that extends over the entirety of the corresponding end face 14 and portions of the bottom face 10, the top face 12, and the pair of side faces 16 adjacent to the end face 14. When the five-sided electrode is formed by dipping into a conductive resin, it is not necessary to perform the base-body protection layer formation step.

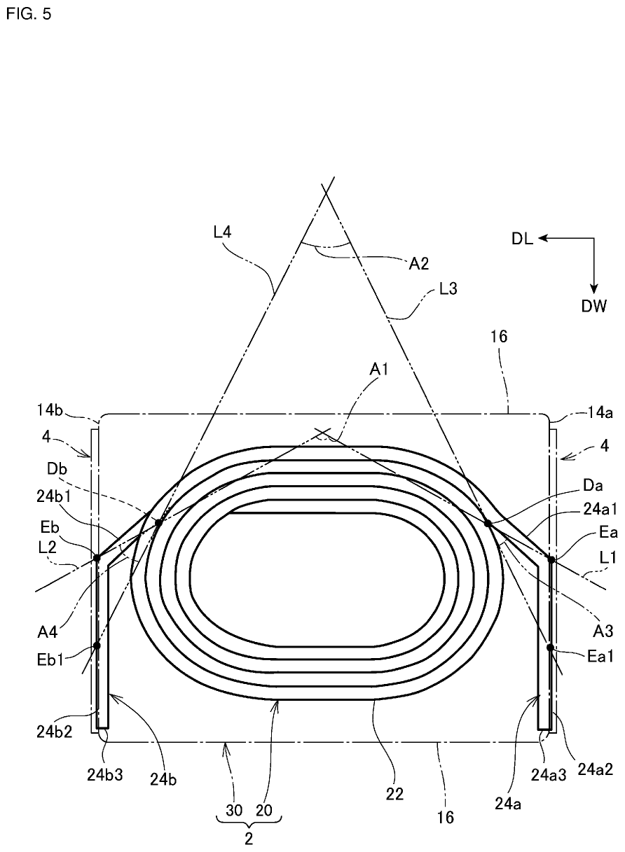

FIG. 5 is a plan view of the coil conductor 20 viewed in the thickness direction DT. In other words, FIG. 5 illustrates the coil conductor 20 viewed in a direction along the central axis of the coil conductor 20.

In the following description, the two end faces 14 are distinguished from each other and referred to as end faces 14a and 14b. In the following description, the two extended sections 24 are distinguished from each other and referred to as extended sections 24a and 24b.

As illustrated in FIG. 5, the extended sections 24a and 24b respectively include transition portions 24a1 and 24b1 and exposed portions 24a2 and 24b2. The transition portions 24a1 and 24b1 are portions of the extended sections 24a and 24b that extend from portions of the wound section 22 that are curved in an arc shape at the outer periphery of the wound section 22. The transition portions 24a1 and 24b1 extend from points at which the transition portions 24a1 and 24b1 extend away from the wound section 22 to the end faces 14a and 14b, respectively. In other words, the transition portions 24a1 and 24b1 connect the wound section 22 to the exposed portions 24a2 and 24b2. The lengths of the transition portions 24a1 and 24b1 affect the direct-current resistance of the inductor 1. As the lengths of the transition portions 24a1 and 24b1 decrease, the direct-current resistance of the coil conductor 20 decreases, and the direct-current resistance of the inductor 1 decreases accordingly.

The exposed portions 24a2 and 24b2 are portions of the extended sections 24a and 24b that are exposed on the end faces 14a and 14b, respectively. The exposed portions 24a2 and 24b2 are formed by bending portions of the extended sections 24a and 24b including ends 24a3 and 24b3 in a direction along the curve of the wound section 22. The exposed portions 24a2 and 24b2 extend along the end faces 14a and 14b. The exposed portions 24a2 and 24b2 are covered by respective ones of the outer electrodes 4. The exposed portions 24a2 and 24b2 affect the direct-current resistance of the inductor 1. As the area of the regions in which the exposed portions 24a2 and 24b2 are exposed on the end faces 14a and 14b increases, the direct-current resistance between each outer electrode 4 and the coil conductor 20 decreases, so that the direct-current resistance of the inductor 1 decreases. In addition, as the area of the regions in which the exposed portions 24a2 and 24b2 are exposed on the end faces 14a and 14b increases, the outer electrodes 4 are more strongly connected to the coil conductor 20.

In the following description, the points at which the transition portions 24a1 and 24b1 extend from the wound section 22 are referred to as extending points Da and db. The extending points Da and db are points of the ends of the transition portions 24a1 and 24b1 adjacent to the wound section 22. As illustrated in FIG. 3, the wound section 22 is wound in two layers arranged in the thickness direction. The extended section 24a extends from the upper layer of the wound section 22, and the extended section 24b extends from the lower layer of the wound section 22. In FIG. 5, the lower layer of the wound section 22 is positioned behind the upper layer of the wound section 22 in the direction orthogonal to the plane of FIG. 5. Therefore, the outline of the conductive wire 20a is shown by dashed lines in a region around the extending point db. The points at which the exposed portions 24a2 and 24b2 start to appear on the end faces 14a and 14b are referred to as exposed points Ea and Eb. The exposed points Ea and Eb are points of the ends of the transition portions 24a1 and 24b1 adjacent to the ends 24a3 and 24b3 of the extended sections 24a and 24b, respectively, and are points of the ends of the exposed portions 24a2 and 24b2 adjacent to the wound section 22. Detailed definitions of the extending points Da and db and the exposed points Ea and Eb will be described below.

FIG. 5 illustrates tangent lines L3 and L4 of the outer periphery of the wound section 22 at the extending points Da and db, respectively. FIG. 5 also illustrates a straight line L1 connecting the extending point Da and the exposed point Ea and a straight line L2 connecting the extending point db and the exposed point Eb.

As illustrated in FIG. 5, the transition portions 24a1 and 24b1 of the extended sections 24a and 24b are bent away from the wound section 22 in the vicinity of the extending points Da and db, respectively. In other words, the transition portions 24a1 and 24b1 are bent in a direction opposite to the direction along the curve of the wound section 22 in the vicinity of the extending points Da and db. Therefore, the transition portion 24a1 extends in a direction angled from the tangent line L3 toward the end face 14a. The transition portion 24b1 extends in a direction angled from the tangent line L4 toward the end face 14b. In the coil conductor formation step, the transition portions 24a1 and 24b1 are bent in a direction in which the extended sections 24a and 24b extending from the wound section 22 are separated from the wound section 22, that is, in a direction opposite to the direction in which the wound section 22 is wound.

Since the transition portion 24a1 extends in a direction angled from the tangent line L3 toward the end face 14a, the exposed point Ea is positioned to face the wound section 22 with the tangent line L3 disposed therebetween when viewed in the thickness direction DT. Similarly, since the transition portion 24b1 extends in a direction angled from the tangent line L4 toward the end face 14b, the exposed point Eb is positioned to face the wound section 22 with the tangent line L4 disposed therebetween when viewed in the thickness direction DT. Thus, the distance between the exposed point Ea and the extending point Da is less than the distance between the extending point Da and an intersection point Ea1. The intersection point Ea1 is a point at which the exposed portion 24a2 and the tangent line L3 intersect when viewed in the thickness direction DT. Similarly, the distance between the exposed point Eb and the extending point db is less than the distance between the extending point db and an intersection point Eb1. The intersection point Eb1 is a point at which the exposed portion 24b2 and the tangent line L4 intersect when viewed in the thickness direction DT. Thus, the lengths of the transition portions 24a1 and 24b1 are reduced.

More specifically, the transition portion 24a1 extends in a direction angled from the tangent line L3 toward the end face 14a by an angle A3 when viewed in the thickness direction DT. When viewed in the thickness direction DT, the straight line L1 connecting the extending point Da and the exposed point Ea and the tangent line L3 intersect to form the angle A3. The transition portion 24b1 extends in a direction angled from the tangent line L4 toward the end face 14b by an angle A4 when viewed in the thickness direction DT. When viewed in the thickness direction DT, the straight line L2 connecting the extending point db and the exposed point Eb and the tangent line L4 intersect to form the angle A4. In the present embodiment, the angles A3 and A4 are greater than 0 degrees, and may differ from each other.

As illustrated in FIG. 5, the straight lines L1 and L2 intersect to form a first angle A1 when viewed in a direction along the central axis of the coil conductor 20. As described above, the transition portions 24a1 and 24b1 extend in directions angled from the tangent lines L3 and L4 toward the end faces 14a and 14b, respectively. Therefore, when viewed in the direction along the central axis of the coil conductor 20, the first angle A1 is greater than a second angle A2, which is the angle between the tangent lines L3 and L4.

As the first angle A1 increases, the transition portions 24a1 and 24b1 are angled further toward the end faces 14a and 14b. Therefore, as the first angle A1 increases, the lengths of the transition portions 24a1 and 24b1 decrease. As the first angle A1 increases, the lengths of the exposed portions 24a2 and 24b2 increase. However, as the first angle A1 increases, the exposed portions 24a2 and 24b2 are formed by bending the extended sections 24a and 24b by greater angles in the direction along the curve of the wound section, and it becomes more difficult to process the coil conductor 20. Therefore, the first angle A1 is preferably 75 degrees or more and less than 180 degrees (i.e., from 75 degrees to less than 180 degrees). More preferably, the first angle A1 is 85 degrees or more and 105 degrees or less (i.e., from 85 degrees to 105 degrees). In the present embodiment, the first angle A1 is 95 degrees.

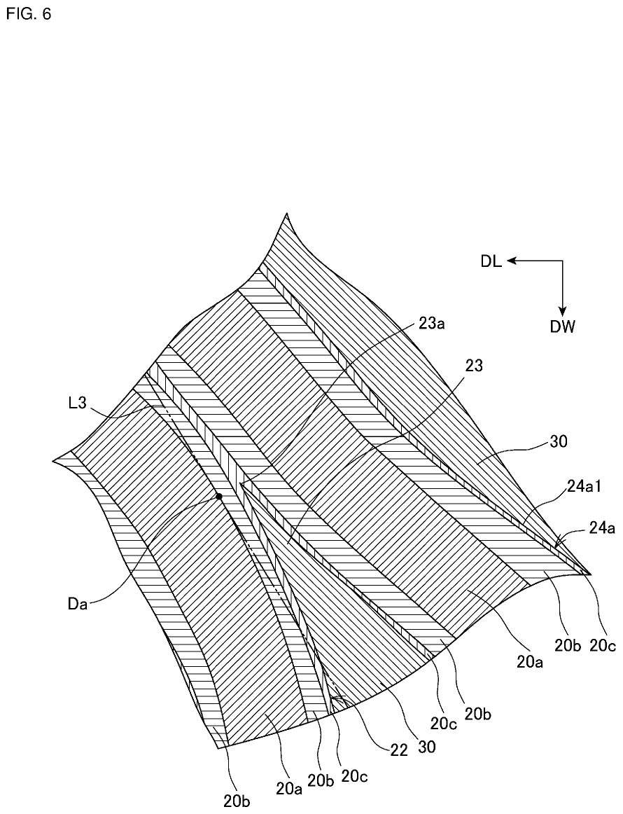

FIG. 6 is a sectional view of a relevant part of the coil conductor 20 taken along a plane parallel to the top face 12 in a region including the extending point Da.

As illustrated in FIG. 6, the extended section 24a extends from the wound section 22 so that a separating portion 23, which is a wedge-shaped gap, is formed between the extended section 24a and the wound section 22. The separating portion 23 is filled with the mixed powder forming the core 30. The separating portion 23 is formed by splitting the fusion layer 20c into two parts in the region between the covering layer on the conductive wire 20a at the outer periphery of the wound section 22 and the covering layer on the conductive wire 20a of the transition portion 24a1.

As described above, the extending point Da is the point at which the transition portion 24a1 extends from the wound section 22. More specifically, the extending point Da is defined as a point that is on the conductive wire 20a at the outer periphery of the wound section 22 and that is closest to an end 23a of the separating portion 23. The position of the extending point Da can be regarded as the position of a point closest to the end 23a of the separating portion 23 on the conductive wire 20a at the outer periphery of the wound section 22 on any sectional view taken along a plane including the wound section 22 and the extended section 24a and parallel to the top face 12.

As described above, the tangent line L3 is a tangent line of the outer periphery of the wound section 22 at the extending point Da. More specifically, the tangent line L3 is a tangent line of the conductive wire 20a at the extending point Da. The tangent line L3 is defined on a see-through view of the inductor 1 viewed in the direction normal to the top face 12 or on any sectional view taken along a plane including the wound section 22 and the extended section 24a and parallel to the top face 12.

Similarly to the extending point Da, the extending point db is a point that is on the conductive wire 20a at the outer periphery of the wound section 22 and that is closest to an end 23a of a separating portion 23 formed between the extended section 24b and the wound section 22. Similarly to the tangent line L3, the tangent line L4 is a tangent line of the conductive wire 20a at the extending point db.

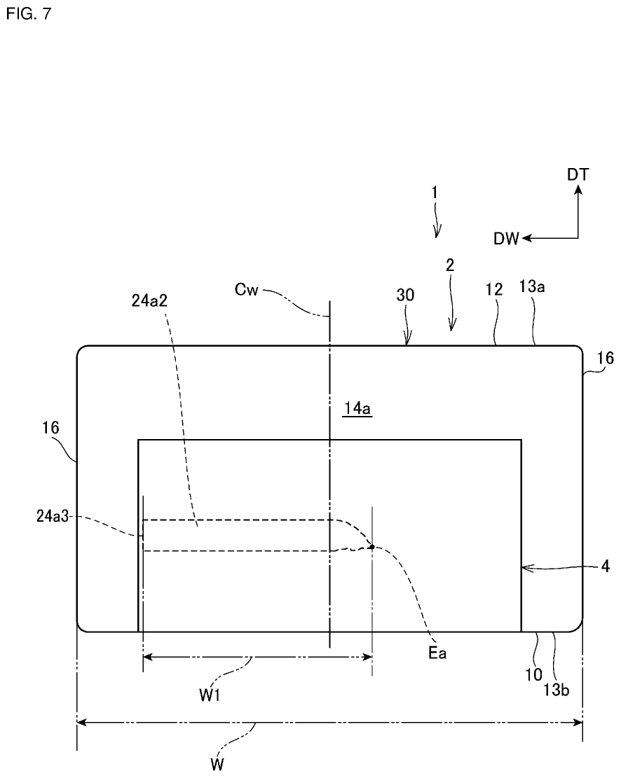

FIG. 7 is a side view of the inductor 1 viewed from the side of the end face 14a.

As illustrated in FIG. 7, the exposed point Ea is a point on the exposed portion 24a2 that is farthest from the end 24a3 of the extended section 24a in the direction normal to the side faces 16.

As illustrated in FIG. 7, when viewed in the length direction DL, the exposed portion 24a2 preferably crosses a bisector Cw of the end face 14a that passes through the midpoint of a side 13a and the midpoint of a side 13b. In other words, the end 24a3 of the extended section 24a is preferably positioned to face the exposed point Ea with the bisector Cw disposed therebetween when viewed in the length direction DL. Accordingly, the length along the conductive wire from the wound section 22 to the exposed portion 24a2 is reduced, so that the direct-current resistance of the inductor 1 can be reduced.

As described above, as the area of the regions in which the exposed portions 24a2 and 24b2 are exposed on the end faces 14a and 14b increases, the direct-current resistance of the inductor 1 decreases, and the outer electrodes 4 are more strongly connected to the coil conductor 20. Therefore, a length W1 of the exposed portions 24a2 and 24b2 is preferably as long as possible. More specifically, to reduce the direct-current resistance of the inductor 1 and strongly connect the outer electrodes 4 to the coil conductor 20, the length W1 is preferably 1/7 or more and ½ or less (i.e., from 1/7 to ½) of the width W between the pair of side faces 16. When the length W1 is less than 1/7 of the width W, the direct-current resistance of the inductor 1 is adversely affected. When the length W1 is greater than ½ of the width W, the coil conductor 20 cannot be easily placed in the mold.

Similarly to the exposed point Ea, the exposed point Eb is a point on the exposed portion 24b2 that is farthest from the end 24b3 of the extended section 24b in the direction normal to the side faces 16. Similarly to the exposed portion 24a2, the exposed portion 24b2 preferably crosses a bisector of the end face 14b that passes through the midpoint of the side between the top face 12 and the end face 14b and the midpoint of the side between the bottom face 10 and the end face 14b when viewed in the length direction DL. Similarly to the exposed portion 24a2, a length of the exposed portion 24b2 in the direction along the side between the top face 12 and the end face 14b and the side between the bottom face 10 and the end face 14b is preferably 1/7 or more and ½ or less (i.e., from 1/7 to ½) of the width W between the pair of side faces 16.

### Other Embodiments

Although the inductor 1 is described as an example in the above-described embodiment, the present disclosure may similarly be applied to any electronic component that is other than an inductor and that includes a wiring layer having a structure similar to that of the coil conductor 20.

Although each separating portion 23 is formed by splitting the fusion layer 20c into two parts in the above-described embodiment, the separating portion 23 is not limited to this. The separating portion 23 may be any gap that is formed between the conductive wire 20a at the outer periphery of the wound section 22 and the conductive wire 20a of each of the transition portions 24a1 and 24b1 and that is hollow or filled with the mixed powder forming the core 30.

Although the angle A3 between the straight line L1 and the tangent line L3 is equal to the angle A4 between the straight line L2 and the tangent line L4 in the above-described embodiment, the angles A3 and A4 are not limited to this. For example, the angle A3 may be greater than the angle A4. Alternatively, the angle A3 may be less than the angle A4. Thus, in the inductor 1, the angles A3 and A4 may be different angles, and the extended sections 24a and 24b may be asymmetrical to each other.

In the above-described embodiment, the transition portion 24a1 extends in a direction angled from the tangent line L3 toward the end faces 14a, and the transition portion 24b1 extends in a direction angled from the tangent line L4 toward the end face 14b. However, the transition portions 24a1 and 24b1 are not limited to this. For example, the transition portion 24a1 may extend in a direction angled from the tangent line L3 toward the end face 14a while the transition portion 24b1 extends in a direction that is not angled from the tangent line L4 toward the end face 14b. Thus, at least one of the two transition portions 24a1 and 24b1 extends in a direction angled from the corresponding one of the tangent lines L3 and L4 toward the corresponding one of the end faces 14a and 14b. In this case, one of the two exposed points Ea and Eb is disposed on the corresponding one of the tangent lines L3 and L4 or on the same side of the corresponding one of the tangent lines L3 and L4 as the wound section 22, and the other one of the two exposed points Ea and Eb is disposed on a side of the corresponding one of the tangent lines L3 and L4 that is away from the wound section 22.

In the above-described embodiment, both the exposed portions 24a2 and 24b2 cross the bisectors of the respective end faces 14a and 14b in the width direction DW when viewed in the length direction DL. However, the exposed portions 24a2 and 24b2 are not limited to this. For example, when viewed in the length direction DL, one of the exposed portions 24a2 and 24b2 may cross the bisector of the corresponding one of the end faces 14a and 14b in the width direction DW while the other one of the exposed portions 24a2 and 24b2 does not cross the bisector. The exposed portions 24a2 and 24b2 are not necessarily parallel to the width direction DW, and may be inclined with respect to the width direction DW. The inclination angle is preferably less than or equal to 15 degrees.

The features of the above-described embodiments and modifications may be applied to any electronic component in combination with each other. For example, an electronic component may include any combinations of the above-described inductors.

Note that each of the above-described embodiments and modifications is an example of one aspect of the present disclosure, and any modifications and applications are possible without departing from the spirit of the present disclosure.

In addition, unless otherwise specified, directions, such as horizontal and vertical directions, various numerical values, shapes, and materials in the above-described embodiments include ranges (so-called equivalent ranges) in which the same effects as those of the directions, numerical values, shapes, and materials are obtained.

Configurations Supported by the Embodiments

The above-described embodiments support the following configurations.
(Configuration 1) An inductor including a base body including a coil conductor and a core in which the coil conductor is embedded. The coil conductor includes a wound section in which a conductive wire is wound. The base body is substantially rectangular-parallelepiped-shaped and includes a pair of principal faces that are opposite to each other, a pair of side faces that are opposite to each other and adjacent to the principal faces, and two end faces that are opposite to each other and adjacent to the principal faces and the side faces. Two extended sections extend from respective ones of two extending points on an outer periphery of the wound section. The two extended sections includes respective transition portions and respective exposed portions, the transition portions connect the extending points to exposed points exposed on the two end faces of the base body, and the exposed portions are exposed on the end faces. The two exposed portions are connected to respective outer electrodes, and at least one of the exposed points is positioned to face the wound section with a tangent line disposed therebetween when viewed in a direction normal to the principal faces. The tangent line is a tangent line of an outer periphery of the wound section at a corresponding one of the extending points.

According to the inductor of Configuration 1, the length along the conductive wire in a portion of at least one of the extended sections that connects the wound section to the exposed portion is reduced. Therefore, the direct-current resistance of the inductor can be reduced. In addition, the length of the exposed portion is increased, so that the direct-current resistance between the corresponding outer electrode and the exposed portion is reduced, and the direct-current resistance of the inductor can be reduced accordingly.
(Configuration 2) The inductor according to Configuration 1, wherein a length of at least one of the exposed portions along sides between a corresponding one of the end faces and the principal faces is 1/7 or more and ½ or less (i.e., from 1/7 to ½) of a distance between the two side faces that are opposite to each other.

According to the inductor of Configuration 2, the direct-current resistance between at least one of the exposed portions and the corresponding outer electrode is reduced, and the direct-current resistance of the inductor can be reduced accordingly. In addition, the exposed portion and the outer electrode can be strongly connected to each other.
(Configuration 3) The inductor according to Configuration 1 or 2, wherein at least one of the exposed portions crosses a bisector of a corresponding one of the end faces, the bisector extending along the corresponding end face and passing through midpoints of sides between the corresponding end face and the principal faces.

According to the inductor of Configuration 3, at least one of the exposed portions and the corresponding outer electrode are connected to each other in a central region of the corresponding end face. Therefore, the length along the conductive wire from the wound section to the exposed portion is reduced, and the direct-current resistance of the inductor can be reduced accordingly.
(Configuration 4) The inductor according to any one of Configurations 1 to 3, wherein two straight lines, each of which connects the exposed point and the extending point of a corresponding one of the extended sections, form a first angle of 75 degrees or more and less than 180 degrees (i.e., from 75 degrees to less than 180 degrees) when viewed in the direction normal to the principal faces, the first angle being greater than a second angle between two tangent lines of the outer periphery of the wound section at the two extending points when viewed in the direction normal to the principal faces.

According to the inductor of Configuration 4, the length along the conductive wire in a portion of each extended section that connects the wound section to the exposed portion is reduced, and the length of the exposed portion is increased. Therefore, the direct-current resistance of the inductor can be reduced.
(Configuration 5) The inductor according to Configuration 4, wherein the first angle is 85 degrees or more and 105 degrees or less (i.e., from 85 degrees to 105 degrees).

According to the inductor of Configuration 5, the length along the conductive wire in a portion of each extended section that connects the wound section to the exposed portion is reduced, and the length of the exposed portion is increased. Therefore, the direct-current resistance of the inductor can be reduced.
(Configuration 6) The inductor according to any one of Configurations 1 to 5, wherein an angle between a straight line connecting the exposed point and the extending point of one of the extended sections and a tangent line of the outer periphery of the wound section at the extending point when viewed in the direction normal to the principal faces differs from an angle between a straight line connecting the exposed point and the extending point of another one of the extended sections and a tangent line of the outer periphery of the wound section at the extending point when viewed in the direction normal to the principal faces.

According to the inductor of Configuration 6, even when the pair of extended sections are asymmetrical to each other, the direct-current resistance of the inductor can be reduced. The difference in angle is, for example, 15 degrees or less.

What is claimed is:

1. An inductor comprising:
a base body including a coil conductor and a core in which the coil conductor is embedded, the coil conductor including a wound section in which a conductive wire is wound,
wherein
the base body is substantially rectangular-parallelepiped-shaped and includes a pair of principal faces that are opposite to each other, a pair of side faces that are opposite to each other and adjacent to the principal faces, and two end faces that are opposite to each other and adjacent to the principal faces and the side faces,
two extended sections extend from respective ones of two extending points on an outer periphery of the wound section, the two extended sections including respective transition portions and respective exposed portions, the transition portions connecting the extending points to exposed points exposed on the two end faces of the base body, the exposed portions being exposed on the end faces,
the two exposed portions are connected to respective outer electrodes, and
at least one of the exposed points faces the wound section with a tangent line disposed therebetween when viewed in a direction normal to the principal faces, the tangent line being a tangent line of an outer periphery of the wound section at a corresponding one of the extending points.

2. The inductor according to claim 1, wherein
a length of at least one of the exposed portions along sides between a corresponding one of the end faces and the principal faces is from 1/7 to ½ of a distance between the two side faces that are opposite to each other.

3. The inductor according to claim 1, wherein
at least one of the exposed portions crosses a bisector of a corresponding one of the end faces, the bisector extending along the corresponding end face and passing through midpoints of sides between the corresponding end face and the principal faces.

4. The inductor according to claim 1, wherein
two straight lines, each of which connects the exposed point and the extending point of a corresponding one of the extended sections, define a first angle of from 75 degrees to less than 180 degrees when viewed in the direction normal to the principal faces, the first angle being greater than a second angle between two tangent lines of the outer periphery of the wound section at the two extending points when viewed in the direction normal to the principal faces.

5. The inductor according to claim 4, wherein
the first angle is from 85 degrees to 105 degrees.

6. The inductor according to claim 1, wherein
an angle between a straight line connecting the exposed point and the extending point of one of the extended sections and a tangent line of the outer periphery of the wound section at the extending point when viewed in the direction normal to the principal faces differs from an angle between a straight line connecting the exposed point and the extending point of another one of the extended sections and a tangent line of the outer periphery of the wound section at the extending point when viewed in the direction normal to the principal faces.
